(19) United States
(12) Patent Application Publication
(10) Pub. No.: US 2005/0147544 A1
(43) Pub. Date: Jul. 7, 2005

(54) Portable ion generator

(76) Inventor: Constantinos J. Joannou, Ottawa (CA)

Correspondence Address: David J. French, P.O. Box 2486, Stn. "D", Ottawa, K1P 5W6, CA

(21) Appl. No.: 10/746,718

(22) Filed: Dec. 29, 2003

(51) Int. Cl. B01J 19/08; B01J 19/12

(52) U.S. Cl. 422/186.04; 422/186.15

(57) ABSTRACT

A battery operated ion source operates independently of the power mains by making contact with surrounding support surfaces which are sufficiently conductive to induce the release of ions from the ion source.

### FIELD OF THE INVENTION

This invention relates to ion generators and in particular battery-operated portable ion generators for personal use. The invention more specifically relates relates to ion generators that operate on surfaces such as those of common tables, desks, cupboards etc.

### BACKGROUND TO THE INVENTION

Negative ion generators have been extensively used for many years to improve the air environment in a room or in a car. Typically these ion generators require power from household outlets or from car cigarette lighter sockets. This fact makes such units awkward to install because of the wires involved.

Ion generators have also been used as air purifiers by acting as dust collectors. An example of such an application is U.S. Pat. No. 5,538,692 (adopted by reference herein) and U.S. application Ser. No. 10/067,433 filed Feb. 7, 2002.

During my experiments with ionizers, I found that a good stream of ions can be produced having a very small current passing through the ionizing needles. For instance 1 microampere of current will produce (10⁻⁶×6.28×10²³) or 6.28×10¹⁷ ions per second where 6.28×10²³× is Avogadro's number, namely the number of electrons in one Coulomb of charge. One coulomb per second is one ampere. Therefore, the number of ions per second generated by a current of one microampere is 628 followed by 15 zeroes.

Assuming the ionizer is powered by a 9 volt battery and assuming an ideal transformation circuit to generate high voltage, the current drawn from the battery would be inversely proportional to the voltage of the battery. Thus, if the ionizing voltage is 6×10³ volts, the battery current drawn from a 9 volt battery would be 1×10⁻⁶×(6×10³/9)=0.666 milliamps. Even if one assumes a 50% efficiency for a practical transformer circuit, a battery current of only be 1.33 milliamps would be required to generate 6.28×10″ ions/sec. Current of this magnitude could be easily accommodated by an ordinary battery, particularly those of the alkaline type.

In order to generate ions, a region of high field gradient must generally be created. A needle as an emitting electrode helps generate ions because the field gradient at the needle tip is inversely proportional to the radius of the needle tip. However, as well as an emitting electrode, there must also be a counter-electrode to form the requisite electrostatic field. The counter-electrode must be connected to an output lead of the high voltage power supply to provide.a current flow through a circuit that includes the ion flow as part of the circuit. Normally this output lead would be grounded to earth through the power source i.e. the grid power outlet or the cigarette lighter socket in a car. But in case of a self-contained unit, there is no readily apparent place for connection of the counter-electrode.

For ion generators supplied power from the grid or mains, capacitive coupling allows the surrounding earth to serve as a counter-electrode. Being remote, the field is spread out in space and if it were not for the size of the earth, the field gradient at the ion emitting electrode may be modest. Connection of the potential source to a more proximate, explicit electrode will increase the field gradient at the ion emitter tip. As well, a counter-electrode of larger area will increase the efficiency of ion emission by the ion emitter tip.

When a battery is used to provide potential for the ion-generating field, a counter-electrode must be connected to the voltage generating circuitry. In the past, this has lead to the construction of explicit counter-electrode surfaces that are necessarily located on or close to the ion generator. Ions emitted in such cases tend to flow to the local counter-electrode. If the object is to cause ions to flow outwardly, to fill part of a room, for example, this effect is limited when an explicit local counter-electrode of limited size is included in the system.

It is therefore an object of my invention to provide an ion generator which is portable, battery operated and can function from the surfaces of tables, desks, cabinets or the like without provision of an explicit counter-electrode as part of the ion-generator structure.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, in each of the individual claims which conclude this Specification.

### SUMMARY OF THE INVENTION

I have previously found that a relatively large conducting body compared to the ion emitter can be made to act as a counter electrode. This can be a large piece of metal that the unit sits on or a human body, as in the case where an ionizer is worn as a pendant. Conveniently, the strap or chain suspending the ionizer may provide the electrical connection to the body. Ions will then be drawn to the body completing the circuit. When a large plate is used as the counter-electrode, it will attract the ions being generated, thus similarly completing the electrical circuit.

I have now discovered that the same result can be achieved by connecting the counter-electrode to a conductive base of the ion generator and placing this base in contact with the surface of a table, desk, cabinet etc, the surface conduction of which is sufficient to provide enough conductivity so that the whole surface will act as the counter-electrode. During my experiments, I found that many of the surfaces of tables, desks, cabinets and the like, have a very small but finite surface conduction. This minute conduction is sufficient to be used as a counter-electrode for a battery operated ion generator.

Surfaces of varnish and plastic are normally thought of as being non-conductive. But, perhaps enhanced by the presence of moisture, such surfaces can be slightly conductive. Due to the very high impedance of the overall ion-generating circuit, the system can tolerate a high resistance inherant in use of a table-top surface etc, as a counter-electrode. This not only provides for the presence of ions in a larger volume of space, but also gives rise to a greater flow of ions in terms of quantity of charge. Thus such an ion generator is more effective in achieving its objective: the supply of ions into a volume of space.

My present invention also provides for an efficient, battery powered voltage converter, in conjunction with making use of the surface conduction of tables, benches etc to act as a counter-electrode. In this way, a portable ion generator can be made which is completely independent of wires attached to it, which will provide ions that spread out over a substantial volume within an occupied environment and will function for a long time.

My invention, in a further aspect is based on a circuit which includes an oscillator which changes the battery voltage from DC to AC. (See U.S. patent application Ser. No. 10/067,433 filed Feb. 7, 2002). The AC voltage is then transformed to a higher voltage by a voltage conversion circuit. Preferably, such a circuit includes a transformer which, eventually, charges an output capacitor. This capacitor can be the last capacitor of a diode-capacitor multiplier circuit in the form of a “ladder” network. Either a single capacitor or group capacitors constitutes a capacitor means, as hereafter so referenced. The capacitors in the bank of capacitors in the diode-capacitor multiplier network each charge individually up to twice the output transformer voltage. The entire diode-capacitor ladder network multiplier can build the voltage up by 10 times or more. The output capacitor in all cases supplies voltage to the ionizing element, e.g. to an ion generating needle(s).

In my experiments, I have found that the voltage on the output capacitor will remain high for a while even after the input the oscillator stops operating. The reason for this is that the ionizing needle(s) take a very small current out of the capacitor (a few microamperes). In view of the above, I reasoned that the oscillator does not have to be operating all the time in order to provide sufficient voltage to the ionizing needle(s). Instead it can operate intermittently. In this way, a lot of energy from the battery can be saved.

Thus, according to another aspect of the invention, the driving oscillator is turned ON for only intermittent intervals, e.g. only approximately one tenth of the time, without much loss of output voltage on the ionizing needle(s). This defines an intermittent duty cycle. In particular, an experimental ionizer operating from a 9-volt battery on a 10% duty cycle has been shown to draw only 120 microamps from the battery and is expected to last for in excess of three months of continuous operation.

The foregoing summarizes the principal features of the invention and some of its optional aspects. The invention may be further understood by the description of the preferred embodiments, in conjunction with the drawings, which now follow.

### BRIEF DESCRIPTION OF THE DRAWINGS

FIG. 1 shows the basic electronic circuit for the battery operated portable ionizer.

FIG. 1a is a timing diagram showing the current waveform over time at the input to the transformer of FIG. 1.

FIG. 1b is a timing diagram showing how the high voltage at the output of the diode-capacitor multiplier varies with time.

FIG. 2 is a practical circuit which produces the waveform of FIG. 1a.

FIG. 3 is a drawing showing a possible arrangement of a practical portable ion generator using its conductive base to come in contact with a furniture upon which the unit sits so that the surface of the furniture acts as the counter-electrode.

### DESCRIPTION OF THE PREFERRED EMBODIMENT

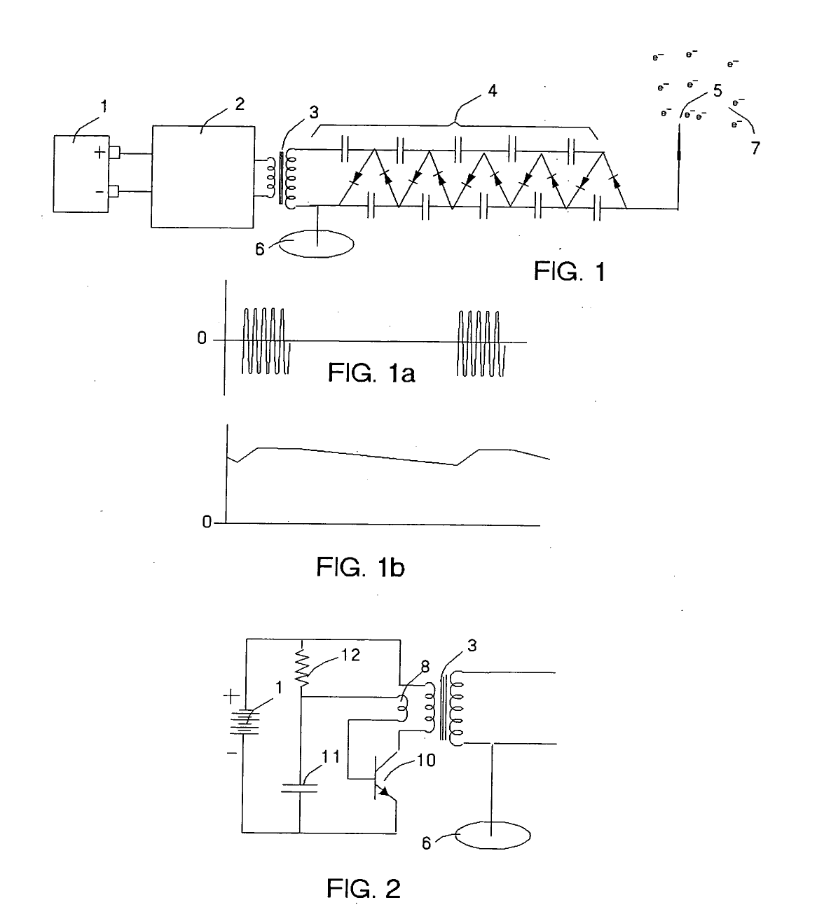

In FIG. 1, a battery 1 supplies power to electronic circuit 2. Circuit 2 provides an AC voltage to transformer 3. Circuit 2 is such that it produces an interrupted or intermittent AC voltage to transformer 3 as shown in FIG. 1a. While a single high voltage transformer may be employed as a voltage conversion circuit, a preferred system relies upon a ladder network as in FIG. 1. During the period of time when circuit 2 is active (ON), the capacitors in the diode-capacitor multiplier 4 get charged up; and during the inactive period (OFF), the capacitors keep their voltage minus a small amount due to current drawn out by the ionizing needle 5 or conductive brush 5.

Connected to the output of transformer 3 is a diode-capacitor multiplier 4 which produces a high voltage (in this case negative) to ionizing needle 5 or brush of conductive fibers which serves on an ion-emitting element. Ions 7 are rapidly repelled outwardly from the tip of the needle 5 by their repulsive charge. A conductive surface 6, is connected to the ground side of the high voltage power supply. This surface 6 is mounted on the ion generator so as to come into contact with the furniture or other support surface that the ion generator sits on, providing and acting as a counter-electrode.

FIG. 1b shows the waveform of the voltage at the ionizing needle or brush. With this arrangement, the ionizing element continues emitting ions even during the time when the circuit 2 is OFF. The ratio of time during which circuit 2 is ON as compared to the time it is OFF, the “duty cycle”, can be as much as 10 to 1 or greater. The current drain on the battery is much smaller than if the circuit 2 were ON continuously. In this way, a battery supplying power to the ionizer unit will last for a very long time with very little sacrifice in efficiency of the ionizer. In one case, an ionizer built using a standard 9 volt alkaline battery is estimated to last for 3 months of continuous operation. Using larger batteries, size C for example, a portable ionizer can be built where the batteries may last for more than a year, subject to their inherent shelf-life.

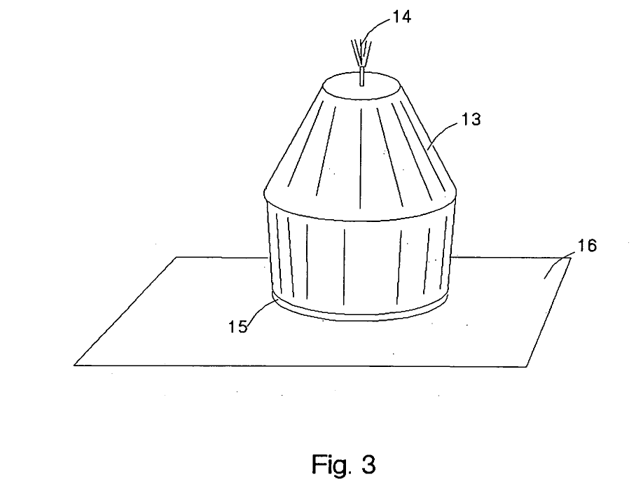

FIG. 2 shows a very simple circuit for an oscillator which can be used to produce the intermittent voltage. A tickler coil 8 on the transformer 3 induces oscillations because the base of transistor 10 receives an out-of-phase voltage from the transformer 3 which produces positive feedback causing oscillations. When the oscillator starts, the base circuit winding produces an AC voltage which gets rectified by the base-emitter junction of the transistor and develops a negative voltage on capacitor 11. This negative voltage buildup eventually biases the transistor OFF. This state lasts until the voltage accumulated on the capacitor 11 leaks off via the resistor 12 and the process starts all over

FIG. 3, shows a possible ion generator which can be made of plastic. The plastic housing 13 of the ion generator carries the ionizing element which is shown here as a conductive brush 14. The base of the ion generator 15 is conductive, or at least sufficiently so to couple the surface 16 upon which the unit rests into a circuit in which such surface 16 serves as a conductive counter-electrode. Thus the base 15 both supports the ion generator on the surface 16, and provides an electrical connection to such surface 16. The material of the base may be in the form of a spongy matrix or a textile which is moderately conductive.

The surface 16 must have a minimal degree of conductivity. It is not expected that this ion generator will work on the top of a glass table with a clean upper surface. But it has been found that many wooden furniture surfaces have sufficient conductivity to allow such surfaces to serve as an effective counter-electrode.

### CONCLUSION

The foregoing has constituted a description of specific embodiments showing how the invention may be applied and put into use. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

1. A battery operated ionizer for producing ions when placed on a support surface having inherant conductivity comprising:
a) battery connected to provide low voltage current to a high voltage power supply;
b) an ionizing element connected to one terminal of said high voltage power supply; and
c) a conducting element connected to the other terminal of said high voltage power supply,
wherein said, high voltage power supply provides high enough voltage to cause ionization by said ionizing element and said conducting element forms the base of the ionizer so that when the ionizer is placed on said support surface it makes contact with such surface whereby said surface, by its inherent conductivity, can act as a counter-electrode.

2. A battery operated ionizer as described in claim 1 where said ionizing element is a needle.

3. A battery operated ionizer as described in claim 1 in which said ionizing element is a conductive brush.

4. A battery operated ionizer as described in claim 1 wherein said conducting element serves as a supporting base for said ionizer.

5. A battery operated ionizer as described in claim 1 wherein said power supply is active intermittently so that it economizes the battery.
